(19) United States
(12) Patent Application Publication
(10) Pub. No.: US 2004/0186868 A1
(43) Pub. Date: Sep. 23, 2004

(54) Digital signal processor for supporting floating point operation

(76) Inventor: Hyo Jin Kim, Seoul (KR)

Correspondence Address: BIRCH STEWART KOLASCH & BIRCH, PO BOX 747, FALLS CHURCH, VA, 22040-0747, US

(21) Appl. No.: 10/758,203

(22) Filed: Jan. 16, 2004

(30) Foreign Application Priority Data
Jan. 16, 2003 (KR) P2003-2990

(51) Int. Cl. G06F 7/38

(52) U.S. Cl. 708/495

(57) ABSTRACT

Disclosed is a digital signal processor with a unit of an integral number, on a basis of a characteristic distributing a sign of data composed of a predetermined unit from MSB (most significant bit) to LSB (least significant bit), changing a negative number to a positive number when the sign of data is the negative number and performing a logical OR operation in accordance with each sign of data so as to support a floating point operation through a sign bit, an efficient number and number of 0 of a final result.

### CROSS-REFERENCE TO RELATED APPLICATIONS

This application claims the benefit of Korean Application No. P2003-02990, filed on Jan. 16, 2003, which is hereby incorporated by reference as if fully set forth herein.

### BACKGROUND OF THE INVENTION

1. Field of the Invention

The present invention relates to a digital processor, and more particularly, to a digital processor for supporting a floating point operation.

2. Description of the Related Art

In general, a digital processor performs data operation. Furthermore, data is extended to a double precision or floating point operation when precision is required.

The double precision is a method or structure for increasing precision by extending a data width of 2N bit when the data width is N bit so as to enlarge a range of efficiency. The double precision requires two times operation cycle and two times memory compared to a single precision.

The floating-point operation is a method for operating data of a floating-point data type. In this case, the floating-point data type is a form employed for describing a real number of the floating point and includes a sign bit, exponent bits, and mantissa bits. The floating-point operation is employed for describing or operating a binary number of data and suitable for describing or operating very large numbers or small numbers.

Although a result of the operation is precise, a unit for performing the floating-point operation has problems in that a logic gate size is large and number of the operation cycle is over 4-5 times of an integer unit.

Meanwhile, the digital signal processor performing an instruction supports an instruction for a block floating point operation. In this case, the block floating point operation initially searches a location of an exponent without adding an operation unit and shifts the data to a left side for extending the range of the significant figure. There are NORM and EXP of TI (Texas instrument Co.), and CLZ of ARM Company as an instruction for the block floating point operation.

However, there is a disadvantage of generating a cycle overhead of the instruction although the aforementioned instruction and structure functionally supports the block floating point. In other words, since the NORM instruction of TI searches bits of data from MSB (most significant bit) to LSB (least significant bit), number of cycle as much as data width is needed for calculating the exponent value of data.

Although the Exp and CLZ instructions calculating the exponent value of one cycle are more advanced instructions than the NORM instruction, there is a problem requiring a predetermined routine calculating a maximum and minimum values of each exponent for calculating a representative exponent value having a predetermined data size.

In other words, there is a problem that the cycle is elongated with more bits sampled from data because the routine additionally requires (N²+N )/2 cycle. In this case, N is the number of data in one block.

### SUMMARY OF THE INVENTION

Accordingly, the present invention is directed to a digital processor for supporting a floating point that substantially obviates one or more problems due to limitations and disadvantages of the related art.

An object of the present invention is to provide a digital processor supporting a floating-point operation for enabling the floating-point operation without many cycle overheads at a processor with an integral number unit.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a digital signal processor supporting a floating-point operation includes a data register for storing data, an inverter for receiving the data and negating when the data is a negative number, a multiplexer for outputting an output value from the inverter and the data register in accordance with a predetermined rule, an OR operator for performing a logical OR operation to an accumulated value and an output value from the multiplexer, an accumulator for receiving and accumulating a result of the logical OR operation, and feedbacking the accumulated result to an input end of the OR operator, and an exponent extractor for extracting an exponent from the accumulated result.

In this case, the predetermined rule processes an ORC instruction and the result value of the inverter is outputted when the MSB (most significant bit) of the data is 1

The accumulator includes a repeater having a loop structure for performing a repeated movement as much as the number of blocks of the data, and a repeater counter for numbering the repeated movement. The accumulator stores a first number and last number of the block.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a diagram showing a digital signal processor supporting a floating-point operation in accordance with the present invention.

FIG. 2 illustrates a diagram showing a method of displaying an 8bit integral or decimal number.

FIG. 3 illustrates a diagram showing an embodiment of a digital signal processor supporting a floating-point operation applied to a real microprocessor unit.

### DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

The present invention, on a basis of a characteristic of a sign of data formed in unit of a predetermined block unit, changes a negative number to a positive number when the sign of data is the negative number and performs a logical OR operation in accordance with each sign of data so as to support a floating point operation through a sign bit, an efficient number and number of 0 of a final result. Number of the sign bit of the data is the exponent. Accordingly, when the data is shifted to a left side as much as the exponent, the efficient number bit is located to under the sign bit. Therefore, as aforementioned, a representative exponent value is obtained by N cycle from data composed of the predetermined block unit.

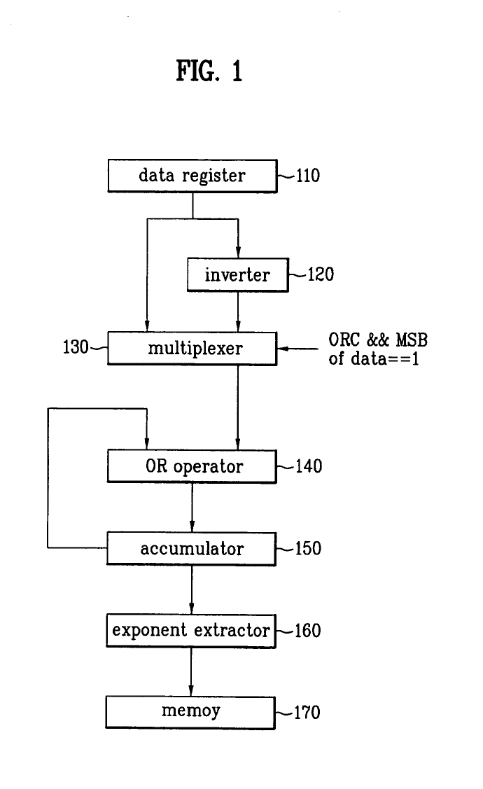

Hereinafter, an embodiment of the present invention will be described referring to appended drawings. FIG. 1 illustrates a diagram showing a digital signal processor supporting a floating-point operation in accordance with the present invention.

As illustrated in FIG. 1, the digital signal processor includes a data register 110 for storing input data, an inverter 120 for receiving the input data and negating the data when the input data is a negative number, a multiplexer 130 for outputting an output value of the inverter 120 and the data register 110 in accordance with a predetermined rule, an OR operator 140 for operating a logical OR to an accumulated value and an output value from the multiplexer 130, an accumulator 150 for receiving and accumulating the logical OR operated value and feedbacking the accumulated value to an input end, a extractor for extracting an exponent from the accumulated value and a memory 170 for storing the final result.

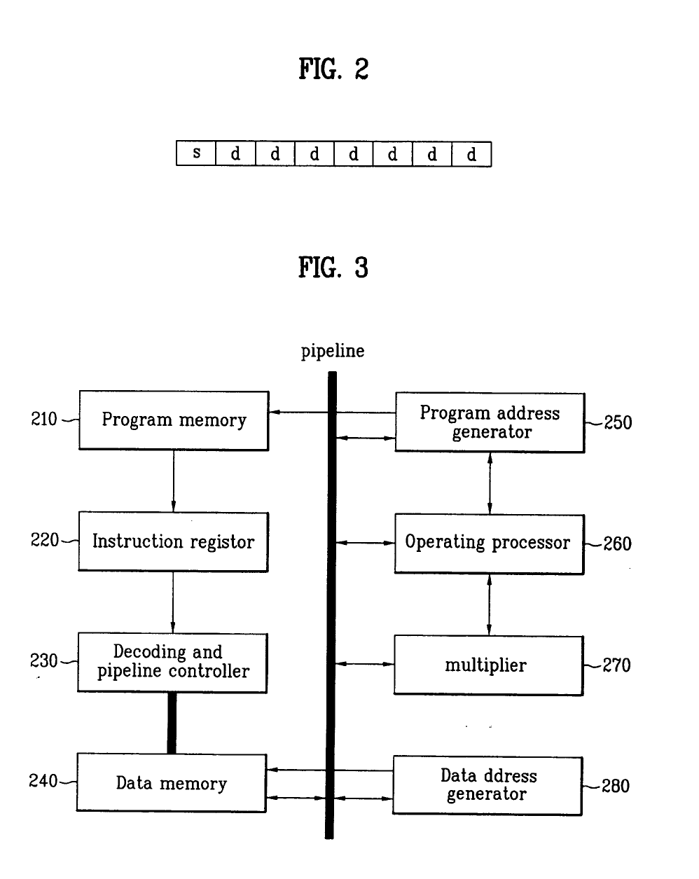

A movement of the digital signal processor supporting the floating-point operation will be described. First, the data register 110 stores data at need of floating-point process by a data loading instruction. If there is a data block including an 8 bit of integral number or decimal number, the data is stored to the data register in a method of FIG. 2. In this case, MSB is a sign bit and rest bit is a validated sign bit.

The inverter 120 receives and negates the data stored in the data register 110 so as to output to the multiplexer 130. In this case, the data is negated when the sign bit is 1. In other words, a negative number is negated. Therefore, the sign bit is filled with 0, 0 remains in a part without an efficient number, and 1 remains in another part with the efficient number.

The multiplexer 130 receives data of the data register 110 or the negated data and input one of the data to the OR operator 140 in accordance with a predetermined rule. In this case, the predetermined rule processes the ORC instruction when data of MSB is 1. In other words, data passed through the inverter 120 is outputted in a case of the negative number, or stored to the data register 110 in a case of the positive number. The OR operator 140 performs the logical OR operation to feedbacked data from the accumulator 150 and the data received form the multiplexer 130.

The accumulator 150 receives and accumulates the result of the logical OR operation so as to feedback the accumulated result to an input end of the OR operator 140. Data stored in the accumulator 150 is outputted to the exponent extractor 160.

For this, the accumulator 150 includes a repeater (not shown) having a structure of loop for repeating as much as a block number of the data, and a repeater counter (not shown) numbering the repeated movement for storing a starting number and a last number of the block.

As a result, the accumulated result value is outputted to the exponent extractor 160. And, the exponent extractor 160 extracts the exponent from the accumulated result value. In other words, except the sign bit, the 0 numbers continuously remained from the MSB become the exponent. Therefore, the result is stored in the memory 170. The instruction processed as mentioned above is called as ORC instruction.

For example, if four blocks of data such as 00001010, 11100101, 00011110, and 11111000 are applied to the present invention, the last data to be stored to the memory is 00011111. In this case, the exponent is 2. When the ORC instruction is performed, the exponent and the efficient number are stored to the memory. FIG. 3 illustrates a diagram showing an embodiment applying a digital signal processor supporting a floating-point operation to a real microprocessor unit.

As illustrated in the drawing, the microprocessor unit includes a program memory 210 for storing a program with a predetermined instruction, an instruction register 220 for fetching and storing the instruction of the program a decoding and pipeline controller 230 for controlling a pipeline necessary for performing a corresponding instruction by decoding the instruction, a data memory 240 for storing data, a program address generator 250 for generating a program address to be currently performed and transmitting the program address to the program memory 210, a data address generator 280 generating a data address for inputting and outputting the data memory through a control of the decoding and pipeline controller, an operating processor 260 for performing calculation, logic, multiplication for a data operation, a multiplier 270 for performing a multiplication needed for the data operation.

In this case, the operating processor 260 includes a similar structure as FIG. 1. In this case, an adder, divider and a multiplexer are further included to the processor illustrated in FIG. 1, an adder (not shown) and a divider (not shown) for performing an operation except the ORC operation, and a multiplexer (not shown) for storing the result value of the ORC operator 140 to the accumulator 150 when the currently performed instruction is the ORC operation, or storing the result value of the adder and the divider to the accumulator 150.

The movement of the microprocessor is described as follows. First, the program memory 210 stores the predetermined instruction in a program form. Data corresponding to the correspondent instruction is stored to the data memory 240. Accordingly, a program-address generating member 250 transmits an address of a part with the instruction to be performed to the program memory 210. When the corresponding instruction is performed, the addresses needed for the instruction and for performing the instruction are fetched to the instruction register 220. The decoding and pipeline controller 230 decodes the instruction and controls the pipeline related to the corresponding instruction. For example, in a case of the ORC instruction, the data memory 240, the operating processor 260, and the data address generator 280 are controlled. In this case, the data address generator 280 returns a number of data needed for performing the instruction whenever called, the number stored in the data memory 240. In a case of another instruction, the multiplier 240 may also be called. And, the result value of the ORC instruction is stored in the data memory 240.

Accordingly, if a cycle for obtaining the representative exponent is compared, in the NORM instruction of TI320CMS2X of Texas Instrument, number of cycle needed for obtaining 24 bit data is 24, and the number of cycle needed for obtaining the representative exponent of data composed of N number of blocks is N(N+25)/2. In the EXP instruction of TI320CMS54 of Texas Instrument company, the number of cycle needed for obtaining 24 bit data is 1, and the number of cycle needed for obtaining the representative exponent of data composed of N number of blocks is N(N+2)/2.

Meanwhile, in the CLZ instruction of ARM company, the number of cycle needed for obtaining 24 bit data is 1, and the number of cycle needed for obtaining the representative exponent of data composed of N number of blocks is N(N+1)/2. However, in the ORC instruction of the present invention, the number of cycle needed for obtaining 24 bit data is 1, and the number of cycle needed for obtaining the representative exponent of data composed of N number of blocks is N.

As described above in detail, in the digital signal processor supporting the floating point operation, only N (number of data in one block) cycle of the representative exponent value of the data is obtained by using a characteristic that each data is distributed from MSB to LSB. Therefore, there is an effect enabling an operation of the floating point without many cycle overheads at the processor having a unit of an integral number.

The digital signal processor supporting the floating point operation in accordance with the present invention includes a hundreds of gate counts additionally added, and the number of cycle needed for obtaining the representative exponent to increase a dynamic range is N/2 order compared to the instruction currently employed. Therefore, the digital signal processor has an effect very helpful from an MIPS side.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A digital signal processor supporting a floating point, comprising:
a data register for storing data;
an inverter for receiving the data and negating when the data is a negative number;
a multiplexer for outputting an output value from the inverter and the data register in accordance with a predetermined rule;
an OR operator for performing a logical OR operation to an accumulated value and an output value from the multiplexer;
an accumulator for receiving and accumulating a result of the logical OR operation, and feedbacking the accumulated result to an input end of the OR operator; and
an exponent extractor for extracting an exponent from the accumulated result.

2. The digital signal processor supporting a floating point of claim 1, wherein the predetermined rule processes an ORC instruction and the result value of the inverter is outputted when the MSB (most significant bit) of the data is 1.

3. The digital signal processor supporting a floating point of claim 1, wherein the accumulator comprises:
a repeater having a loop structure for performing a repeated movement as much as the number of blocks of the data; and
a repeater counter for numbering the repeated movement.

4. The digital signal processor supporting a floating point of claim 3, wherein the accumulator stores a first number and last number of the block.

5. A digital signal processor supporting a floating point, comprising:
a program memory for storing a program with a predetermined instruction;
an instruction register for fetching and storing the instruction of the program;
a decoding and pipeline controller for decoding the instruction so as to control pile line needed for performing a correspondent instruction;
a data memory for storing data;
a program address generator for generating a program address to be currently performed and transmitting the program address to the program memory;
a data address generator generating a data address for inputting and outputting the data memory through a control of the decoding and pipeline controller;
an operating processor performing calculation, logic, multiplication for a data operation; and
a multiplier 270 for performing multiplication needed for the data operation.

6. The digital signal processor supporting a floating point of claim 5, wherein the operating processor comprises:
a data register for storing data;
an inverter for receiving the data and negating the data when the data is a negative number;
a multiplexer for outputting an output value from the inverter and the data register in accordance with a predetermined rule;
an OR operator for performing a logical OR operation to an accumulated value and an output value from the multiplexer;
an accumulator for receiving and accumulating a result of the logical OR operation, and feedbacking the accumulated result to an input end of the OR operator; and
an exponent extractor for extracting an exponent from the accumulated result.

7. The digital signal processor supporting a floating point of claim 6, wherein the operating processor comprises:
an adder and a divider for performing an operation except an ORC operation; and
a multiplexer for storing a result value of the OR operator to the accumulator when the currently performed instruction is the ORC operation, or storing the result value of the adder and the divider to the accumulator 150.

8. The digital signal processor supporting a floating point of claim 6, wherein the predetermined rule processes an ORC instruction and the result value of the inverter is outputted when the MSB (most significant bit) of the data is 1.

9. The digital signal processor supporting a floating point of claim 6, wherein the accumulator comprises:
a repeater having a loop structure for performing a repeated movement as much as the number of blocks of the data; and
a repeater counter for numbering the repeated movement.

10. The digital signal processor supporting a floating point of claim 6, wherein the accumulator stores a first number and last number of the block.
